(19) United States
(12) Patent Application Publication
(10) Pub. No.: US 2016/0029659 A1
(43) Pub. Date: Feb. 4, 2016

(54) COATED CHEWING GUM AND ITS PROCESS OF MANUFACTURE

(71) Applicant: PERFETTI VAN MELLE S.P.A., Lainate (Milano) (IT)

(72) Inventors: Roberto Colle, Lainate (IT); Gianni Baldi, Lainate (IT); Maurizio Deleo, Lainate (IT)

(21) Appl. No.: 14/782,045

(22) PCT Filed: Apr. 23, 2014
(86) PCT No.: PCT/EP2014/058182

§ 371 Date: Oct. 2, 2015

(30) Foreign Application Priority Data
Apr. 24, 2013 (IT) MI2013A000686

(51) Int. Cl. A23G 4/20; A23G 4/10

(52) U.S. Cl. CPC A23G 4/20; A23G 4/10; A23V 2002/00

(57) ABSTRACT

The present invention relates to chewing gum having a coating with a satin effect and optionally containing a filling in the form of particulate matter. The invention also relates to methods of obtaining said chewing gum.

The present invention relates to chewing gum with a satin coating and with a particulate filling.

### PRIOR ART

Chewing gum dragée comprise a gum region, with gum base and sweetener and a coating region. The coating region manufactured according to the known techniques, is usually obtained through repetition of a plurality of coating steps and the outermost surface is usually polished. Example of polished dragée are sold under the names of Mentos Pure Fresh® chewing gum, or Orbit ®.

In order to have a polished, smooth and glossy outermost surface, the technician may prepare a smooth coating surface employing particular coating syrups (more diluted or with less binders) in the last coating steps, avoid the use of powders, manipulate process parameters and perform a polishing step employing, in the outermost layer, polishing agents like carnauba wax, shellac, hydrogenated polydecene and others. Polishing agents, in form of powders or liquid are applied in revolving pans over a bed of coated dragée and, through the friction generated by the tumbling dragée, they are distributed in a thin and glossy film. In order to do so pans are left revolving for long periods, up to 30 minutes.

Dragée chewing gums covered with particulate matter are also known, as disclosed for example, in US 8124145, WO 2009138208 and WO 2011158123. However, no specific teachings exist regarding quantitative control of the roughness of the finished product.

Roughness can be measured quantitatively with profilometers, however this technique, to the best of our knowledge, has never been used in the field of confectionery.

Chewing gum covered with particulate matter may have a peculiar appeal and the outermost particulate may anticipate a particulate filling. Chewing gums, possibly also in the dragée form, which contain fillings in the form of particulate matter are disclosed, for example, in EP 0320580 and EP 1151672. However, the Applicant has found that problems of total or partial loss of powdered filling during the manufacturing steps still exist. Said losses can originate in the areas of weakness, or from small holes, in the gum region that surrounds the filling, leading to evident disadvantages during manufacture, as well as reducing the acceptability of the product to consumers. Lost particles from the filling, for example, can stick to the outermost part of the chewing gum, comprising the outermost part of a dragée, altering the roughness or smoothness of the coating.

The Applicant has now found chewing gums which are qualitatively superior to those of the prior art, with controlled roughness with a satin effect and lower losses of particulate filling.

### DESCRIPTION OF THE INVENTION

The chewing gum of the invention comprises at least two regions, the first one is characterised by the presence of a gum base and at least one sweetener, the second one is a coating region comprising more than 50% of sugar or polyols and combinations thereof, wherein the outermost part is has a satin effect and is characterised by a controlled surface roughness with an average roughness Ra ranging between 1 and 6 μm.

In one embodiment, a further region consists of a granular filling, contained inside the gum region, wherein said granular filling is characterized by a particulate material in a quantity higher than 98% and a liquid in quantity comprised between 0.1% and 2% by weight of the filling. “Liquid ingredients” here means substances liquid at room temperature which are added to the granular filling. Liquids contained as residues in the granular part, such as crystallisation water or other liquids trapped in the solid matrix of particulate matter, are therefore excluded.

“Granular filling” means a filling consisting of small solid particles not bound together. For example, a granular filling can consist mainly of sugar crystals of various particle sizes. Alternatively, it can mainly consist of more or less complex granulates. Granular filling can consist of a plurality of ingredients in the form of particulate matter, such as sugars, polyalcohols, flavours, process adjuvants and additives.

The presence of percentages of liquid ingredients, as specified above, in a particulate filling does not modify its appearance as a set of particles, and allows some characteristics, such as flowability, to be qualitatively maintained, albeit in a quantitatively modified form.

The coating region consists of a coating performed according to known techniques, whose outermost part has a satin effect, and is characterised by average roughness Ra ranging between 1 and 6 μm and/or average roughness Rz ranging between 5 and 30 μm.

“Satin effect” means a surface roughness (for simplicity only roughness from here onward) greater than that of the prior art polished chewing gum dragées, but smaller than that of the dragée of the prior art, with a coating whose outermost part is obtained with particulate matter.

A preferred embodiment of the invention is a chewing gum comprising a first region consisting of granular filling, a second region with gum base and at least one sweetener surrounding the filling region, and a third coating region surrounding the second region, the outermost part of which has a satin effect.

Advantages of the preferred embodiment are a controlled roughness of the outermost surface and the absence of powders derived by losses of the filling

The invention also relates to a process for the preparation of said chewing gums. The method comprises the preparation of a gum dough by adding in a mixer and mixing at least one gum base and a sweetener according to known methods.

When the gum dough has been obtained, it is reduced to a plurality of chewing gum pieces, such as sticks or slabs, or a plurality of cores, by one or more of the following processes: extrusion, dye forming, cutting, rolling and scoring.

In one embodiment, a substance in the form of granules having the function of filling the chewing gum pieces or cores is introduced into the mixture at the same time as or after extrusion and before the dye forming, cutting, rolling and scoring steps. The granular filling preferably comprises solids with a negative heat of solution, in particular polyalcohols.

The method for manufacturing the chewing gum of the invention comprises the application of a coating, omitting the polishing step as described.

Many types of coating are possible, but for the scope of the invention, coating means one or more layers of hard coating, soft coating and combinations thereof. Coating can be based on sugar or on polyols, alone or in combination thereof.

Coating can be performed in pans and can comprise the application of powders, application of one or more layers of engrossing and smoothing syrup.

According to the invention, a finishing with controlled roughness with a satin effect is obtained by means of a controlled process characterised by the absence of a polishing step and preferably employing only one type of syrup, thus simplifying the coating operations. The invention is thus advantageous since no polishing step is required and only one type of syrup has to be prepared, with consequent savings in time and costs of raw materials.

The chewing gum with a satin finish of the invention may be prepared by a process, wherein dry semi-finished dragées, coated from 50% to 99% of the coating weight, are subjected to a final coating step comprising

i) coating with syrup;

ii) dusting with a coating material in powder comprising polyols;

iii) drying with air;

until 100% of the coating weight is obtained with an outermost satin coating.

Preferably the steps i)-iii) are repeated less than four times. The powder according to the invention providing the satin effect either consists of a single material or comprises a combination different materials, preferably two different materials.

The satin coating of the outermost part can be obtained, independently of the presence of granular filling, by the method according to the invention, over chewing gum cores according to the prior art, including cores with liquid filling.

In the filling, core and coating regions, other ingredients, such as additives, flavours, cooling agents, vitamins, minerals and herbal extracts can be added.

### DETAILED DESCRIPTION OF THE INVENTION

The chewing gum of the invention can be made in any shape, such as sticks, slabs, cigarettes, and cushion, rectangular, cube and disc shapes.

The chewing gum of the invention comprises two regions:

a) a gum region characterised by the presence of at least one gum base and at least one sweetener;

b) a coating region comprising more than 50% of sugar or polyols and combination thereof, wherein the outermost part is has controlled roughness with a satin effect and is characterised by an average roughness Ra ranging between 1 and 6 μm.

In a further embodiment the gum can comprise a region consisting of a granular filling, included in the chewing gum region, wherein said granular filling is characterized by a particulate material in a quantity higher than 98% and a liquid in quantity comprised between 0.1% and 2% by weight of the filling. The first two steps of the preparation process involves preparing the region with gum base and at least one sweetener. The first step a) is to obtain a chewing gum dough with known techniques from at least a gum base and a sweetener, from which the cores of the chewing gum in dragée form will be obtained in the second step b)

The gum base can be manufactured according to known techniques.

The sweetener can be selected from sugars (in solid form, such as sucrose and glucose, or in the form of syrup, such as glucose syrup), polyols (in solid form, such as sorbitol, or in the form of syrup, such as maltitol syrup), and combinations thereof. The polyols can be selected from sorbitol, mannitol, maltitol, isomalt (a mixture of glucopyranosyl mannitol and glucopyranosyl sorbitol), erythritol, xylitol, maltitol syrup and mixtures thereof. Various particle size grades are available for each of the ingredients listed, which can be used mixed together, to modulate the hardness, flavour and texture sensation of the chewing gum composition.

The mixture may also contain one or more of the following substances: intensive sweeteners, flavouring agents in solid or liquid form, wetting agents, technological adjuvants such as emulsifiers or plasticisers, active pharmacological ingredients, plant extracts, functional ingredients such as vitamins or mineral salts, and colorants.

The gum dough can be prepared according to any known methodology, for example with the use of continuous extruders or non-continuous mixing apparatuses.

After the dough has been prepared, it is processed to obtain a plurality of pieces of chewing gum or cores, e.g. by extrusion and following dye forming or rolling and scoring.

The manufacturing process can also include a step of introduction into the extruded dough of a substance designed to fill the body of the chewing gum, said introduction step being performed after or at the same time as the extrusion step, and before the rolling or dye forming step. The filling can be liquid, solid, granular or gelatinous. Certain embodiments of the invention require the gum to contain a quantity of filling completely surrounded by the chewing gum region. Liquid or granular filling exits rapidly from the gum during the first steps of chewing, contributing to the initial sensation imparted by the chewing gum.

Moreover, in the case of the preferred granular or powdered fillings, the use of ingredients with a negative heat of solution, such as dextrose, dextrose monohydrate, sorbitol, erythritol and xylitol, and mixtures thereof, contributes to the initial sensation of coolness.

The granular filling preferably comprises particulate matter with at least one of the following: dextrose monohydrate, sorbitol, erythritol and xylitol and mixtures thereof in crystals, in a quantity exceeding 98% of the filling. The filling contains added liquid ingredients in a percentage between 0.1% and 2% by weight of the filling. The average particle size of the particulate matter preferably ranges between 40 μm and 1000 μm, even more preferably between 250 μm and 800 μm; The filling preferably also contains powdered flavours such as menthol and cooling agents, either “as is” or supported or encapsulated.

The particulate filling can contain other ingredients in solid form such as additives, including organic acids, colorants, including lakes and pigments, and process adjuvants, such as starches, modified starches, silica, talc and magnesium stearate.

The granular filling advantageously contains ingredients which are liquid at room temperature, in addition to any residues naturally contained in the filling ingredients. In particular, liquid ingredients with a concentration higher than 0.1% and lower than 1 wt% of the filling are preferably used, including concentrations lower than 0.8 wt%, 0.6 wt%, 0.4 wt% and 0.2 wt% of the filling.

The liquid ingredients can include triglycerides (chain C₆-C₁₂). Said liquid ingredients are preferably constituted by C₆-C₁₂ chain triglycerides. The triglycerides are preferably contained in a percentage lower than 1%, including percentages lower than 0.8%, 0.6%, 0.4% and 0.2% by weight of the filling. Liquid hydrophilic ingredients, such as syrups or aqueous suspensions at various concentrations, contained in the powdered filling in percentages below 0.5%, including concentrations lower than 0.3, 0.1 and 0.05% by weight of the powdered filling, can optionally be present. Hydrophilic liquid ingredients and triglycerides combined with the described percentages can be present simultaneously.

The liquid ingredients therefore preferably constitutes a percentage of the filling ranging between 2% and 0.01%, more preferably between 1% and 0.1% and even more preferably between 0.8% and 0.2% .

The filling in the form of particulate matter preferably comprises xylitol crystals with an average particle size ranging between 250 μm and 1000 μm, in a percentage exceeding 50% by weight of the filling.

The insertion in the granular filling of small percentages of liquid ingredients as described, including triglycerides and hydrophilic liquids, produces a filling with lower losses of filling in the subsequent steps, comprising coating and/or wrapping. In fact some of the particles of the granular filling can leak from the filling region, through defects in the gum region, like the small holes that can be present in the closing areas of moulded chewing gum centres, and cause quality problems. In fact the granules leaked from the filling can spoil the appearance of the coated dragée, by sticking to the outermost part of the coating, damaging the controlled roughness, characterizing the present invention. Leaked granules may eventually and in part soil the internal part of the packaging, in which gum are usually sold, further damaging the quality of the product.

The cores thus obtained are sent to the subsequent manufacturing steps. Coated gums require the application of hard or soft coatings, as described below.

Some embodiments do not include the presence of granular filling. If the consistency of the filling is sufficient, the filling need not be completely surrounded by the chewing gum region, but may be visible on one or more sides.

The chewing gum of the invention includes a coating, that constitutes the coating region. Different forms of coating are possible, the most common being soft coating and hard coating, which can be applied alone or combined with one another.

Soft coating is obtained by applying syrup to the chewing gum cores, followed in sequence by powders or granulates (dusting). The syrup is formed by mono- or disaccharides, possibly hydrogenates, dissolved in water to which polysaccharides such as glucose syrups, or binders such as gum arabic or gelatin, can be added. The powders or granulates can have the same nature as one of the ingredients of the syrup or different ones. For example, if the syrup contains sucrose dissolved in water and gum arabic, sucrose crystals can be used as particulate matter. However, the particulate matter can also consist of more complex materials, such a mix of sugar and gum arabic. The sequence is repeated on one or more times, typically up to 7-10 times. The result is a soft crust, where water is immobilized through distribution over the large surface of the applied powders.

A hard coating is obtained by applying in sequence syrup, powder (optional) and drying air. Times, called distribution times, during which the syrup or powder is evenly distributed over the surface of the balls, can be inserted between applications. In this case, water is removed by drying air, which concentrates the syrup that crystallise in due times. The sequence is repeated on one or more times, even over 20 times. The result, after an optional curing time, is a crunchy crust.

In the context of the invention, the final part of the soft coating or hard coating, is performed taking measures directed to have a surface which is as smooth as possible, before the process steps directed toward the finishing of the coating with an outermost part with controlled roughness.

Those skilled in the art know how to have a smooth final part of the coating, because this is customarily required to prepare the coating for the common polishing step, which constitutes the outermost part of the coating in the vast majority of chewing gum dragée on the market. The skilled technician knows how to control syrup viscosity and concentration (which is usually lowered) and may avoid or reduce dusting in the final syrup application in order to smooth the coating. Process parameters can be also set to help the technician in this direction, like modifying rotation frequency in pans, lowering air temperature (if used), introducing longer distribution times.

Additives and ingredients usually directed to impart a glossy appearance to the outermost part of the coating are preferably absent. These additives and ingredients are usually: natural waxes, synthetic waxes, shellac, alone or in combination with solvents and additives, like oils, alcohol, emulsifiers. Waxes preferably absent from the present invention are: carnauba wax, candelilla, beeswax, petroleum wax, microcrystalline wax, hydrogenated poly-1-decene.

Alternatively, if these polishing agents are present, they are not used to polish the surface. The applicant has found that polishing agents can be used as slip agents for the coated dragée, if they are used in a mix with other powders. Preferably, the finished dragée are not revolved after drying, to avoid smoothening the satin finished surface and the polishing agents, if present, to be spread in a glossy film. Flavours, intensive sweeteners, liquid or powdered colorants, optionally encapsulated or supported, either alone or mixed together, can be used in both types of coating.

Moreover, part of the coating can be obtained by one technique and part by another, thus generating infinite permutations of textures, colours, flavours, etc.

The coating region of the invention includes a satin finishing on the outermost part.

Said effect may be obtained by a process, wherein dry semi-finished dragées, coated from 50% to 99% of the coating weight, are subjected to a final coating step comprising

i) coating with syrup;

ii) dusting with a coating material in powder comprising polyols;

iii) drying with air;

until 100% of the coating weight is obtained with an outermost satin coating.

Preferably the steps i)-iii) are repeated less than four times, more preferably less than three times, most preferably two times.

Distribution times may be inserted after the coating with syrup or the dusting with the powder comprising polyols. A polishing step is not performed. The powder used for the outermost satin coating can be the same as the powders possibly used in other parts of the process or a different one. The powder used for the outermost satin coating preferably comprises and more preferably consists of one of sorbitol, isomalt, maltitol, xylitol, mannitol, erythritol, gum arabic and combinations thereof.

The powder can consist of the same material that constitutes the majority of the coating, or a different material. For example, if the main ingredient of the coating is isomalt, powdered isomalt can be used independently of the glucopyranosylsorbitol:glucopyranosylmannitol (GPS:GPM) ratio. If the major ingredient of the coating is xylitol, the powder can consist of a mixture of mannitol and gum arabic. Alternatively, if the major ingredient of the coating is maltitol, a powdered mixture of maltitol and gum arabic can be used.

Alternatively, the powder used for the outermost satin coating preferably consists of more powders combined among themselves, preferably two or three powders. Preferably a first powder consists of sorbitol, isomalt, maltitol, xylitol, mannitol, erythritol, gum arabic and combinations thereof. Preferably a second powder consists of talc, silicon dioxide, titanium dioxide, magnesium stearate, carnauba wax. Preferably a third powder consists of coloured speckles (also known as edible glitters). Glitter, also known as speckles, are available in different colours and particle sizes, and can be obtained, for example, from Watson Foods Company Inc., 301 Heffernan Dr., West Haven, USA.

The first powder preferably accounts for 50% to 97%, more preferably 65% to 90% of the powder used in the outermost satin coating. The second powder preferably accounts for 0.1% to 10%, more preferably 4% to 9% of the powder used in the outermost satin coating.

Preferably the ratio between the dry coating syrup and the material in powder form used in the satin coating is from 2:1 to 4:1, more preferably from 2.5:1 to 3.5:1. The syrup used in the satin coating is preferably composed by polyols from 60% to 90%, binders from 3% to 9%, water from 10% to 20% (percentages on the wet syrup). Colours, sweeteners and flavours may be present as needed.

More preferably the syrup used in the satin coating is composed by polyols from 70% to 80%, binders from 5% to 8%, water from 12% to 17% (percentages on the wet syrup).

Preferred polyols are xylitol, isomalt, maltitol, mannitol sorbitol and mixtures thereof. A preferred mixture is 3:1 to 5:1 xylitol : mannitol.

Preferred binders are gum arabic, starches (native or modified), maltodextrins, gelatin.

The satin coating is applied over a semi-finished dragée, i.e. a dragée which is not yet completed, but that already has part or even most of the coating. In fact it is preferred that the semi-finished dragée already has from 50% to 99% of the final coating (% by weight of the coating), more preferably from 70% to 99%, even more preferably from 85% to 95% of the final coating. The satin finishing completes the coating to 100%, thus accounting for 1% to 50% of the coating, more preferably from 1% to 30%, even more preferably from 5% to 15% of the coating (% by weight of the coating).

In percentages of the finished product the final satin coating may account for 0.1% to 10%, preferably 0.5% to 5% , more preferably 1% to 4% by weight. “Satin effect” means a low level of roughness, characterised by an average roughness Ra ranging between 1 and 6 μm and/or a roughness Rz ranging between 5 and 30 μm.

The applicant has found that the measure of roughness is reduced in respect to the measure of size of the powder, this can be attributed only to the process as described. In order to control the roughness of the finished piece to the desired values the Applicant has proposed to use powders which are accordingly of higher size than the target roughness.

In fact the powder, used in the process described for the manufacture of the satin finishing on the outermost part of the coating, preferably has an average particle size by weight ranging between 10 μm and 500 μm, more preferably between 30 μm and 400 μm, and even more preferably between 40 μm and 300 μm.

The process thus reduces the irregularity that the powder would provide, if applied unchanged to a surface, yielding a surface with controlled roughness.

Ra can be measured with known roughness testers or profilometers which are available, for example, from Taylor Hobson Ltd, PO Box 36, 2 New Star Road, Leicester, LE4 9JQ (UK). In roughness testers, a very fine tip probes a surface, without damaging it, along a line. Other instruments do not use mechanical probes, but beams of light, such as a laser. From the surface profile detected by the probe, different indexes of surface roughness can be calculated, Ra and Rz being among the most common.

The median profile line, which minimises the sum of the squared distances of the profile points from the median line, is used as reference to measure Ra. The profile is probed and measured along a length L, conventionally established in proportion to the estimated roughness. Taking the median line as the x-axis, Ra is defined as the absolute mean of the values of the profile on a y-axis always orthogonal to x. If a series n of discrete points (xᵢ; yᵢ) on the profile is sampled, Ra can be calculated with the equation:

$$Ra = ( 1 / n ) \cdot {\sum }_{i = 1}^{n} \vert {y}_{i} \vert$$

To measure Rz, reference is made to the five highest peaks along a profile L, with axes y₁, y₂, y₃, y₄, y₅, and to the five lowest valleys, with axes y_{1′}, y_{2′}, y_{3′}, y_{4′}, y_{5′}. Rz is therefore defined by the formula

$$Rz = ( {\sum }_{i = 1}^{5} {y}_{i} - {\sum }_{{i}^{′} = 1}^{5} {y}_{{i}^{′}} ) / 5$$

The y-axes are always measured by reference to the median line, so the y_{i′} values, relating to the valleys have a negative value, and if their sum is subtracted, the result is a positive value.

As Rx is a mean calculated on the maximum values , for the same profile Rz>Ra, the difference between Ra and Rz typically conveys the irregularity of the roughness.

The roughness measurement of an external part of a coating with a satin effect obtained according to the invention is an intermediate value between the roughness of a normally smoothed and polished dragée and a dragée with particulate matter in the outermost part, obtained by the conventional technique. The roughness according to the invention is characterised by an average roughness Ra ranging between 1 and 6 μm and/or an average roughness Rz ranging between 5 and 30 μm. The roughness of a dragée smoothed and polished by the conventional technique and available on the market is typically characterised by mean values of Ra<1 μm and Rz<3 μm. The roughness of a dragée with the outermost layer made of particulate matter obtained by the conventional technique and available on the market is characterised by mean values of Ra>6 μm and Rz>30 μm.

Notably, as Ra and Rz are averaged values, a higher Ra and Rz indicate higher irregularity in a surface. The invention displays a degree of irregularity in its surface that is higher than prior art polished dragées, but lower than prior art particulate coating.

The mean value of Ra is preferably between 2 and 5 μm, and simultaneously the mean value of Rz is between 10 and 25 μm. “Mean value” here means a repetition of the determination of Ra and Rz on a plurality of pieces of coated chewing gum, in particular on ten pieces.

The chewing gum of the invention can contain other conventional ingredients in the filling region, the region with gum base and the coating region. In particular, further sugars, additives, technological adjuvants, flavours, cooling agents, vitamins, minerals and herbal extracts can be used.

The sugars can be used in solid form, such as dextrose or sucrose, or in syrup form, such as glucose syrup.

The additives can include polyalcohols, intensive sweeteners, acidifiers, filling agents, thickeners and wetting agents. The polyalcohols are available in solid form, such as sorbitol, xylitol, mannitol, isomalt, maltitol and erythritol, and liquid form, such as maltitol or sorbitol syrup in solution.

The following examples report chewing gum formulations consisting of a region with gum base and sweeteners.

### EXAMPLE 1

### Region with Gum Base and a Sweetener

| Ingredient | % |
|---|---|
| Gum base | 36.00 |
| Acesulfame K | 0.05 |
| Aspartame | 0.05 |
| Sucralose | 0.10 |
| Mannitol | 10.00 |
| Glycerol | 3.50 |
| Peppermint flavouring in solid form | 1.80 |
| Maltitol | 32.00 |
| Maltitol syrup | 5.00 |
| Peppermint flavouring | 1.50 |
| Sorbitol | 10.00 |
| Total | 100 |

### EXAMPLES 2-6

### Granular Fillings

| | % | | | | |
|---|---|---|---|---|---|
| | | | | 5 | |
| | | | | (WO2011- | 6 |
| Ingredient | 2 | 3 | 4 | 158123) | (reference) |
| Xylitol crystals, | 87.00 | 87.00 | 87.00 | | |
| average particle size 500 μm | | | | | |
| Sorbitol crystals, | 10.45 | 10.00 | 10.2 | | |
| average particle size 200 μm | | | | | |
| Xylitol crystals, | | | | 85.4 | |
| average particle size 700 μm | | | | | |
| Xylitol crystals - | | | | | 96 |
| standard grade - 95% between | | | | | |
| 177 μm and 2380 μm | | | | | |
| Powdered menthol | 2.00 | | | | |
| Powdered solid flavour mix | | | | | 4 |
| Flavour | | | | 10.8 | |
| Soium bicarbonate | | | | 3.8 | |
| Triacetin | 0.50 | 1 | 0.8 | | |
| E133 - aluminium lake | 0.05 | | | | |
| Talc | | 2 | | 1 | |
| Citric acid | | | 2 | | |
| Total | 100 | 100 | 100 | 100 | 100 |
| Physical form | Granular | Granular | Granular | Granular | Granular |
| | particulate | particulate | particulate | particulate | particulate |
| | matter | matter | matter | matter | matter |

### EXAMPLES 7-11

### Gum Centers

Gum dough of Example 1 is subjected to extrusion and dye forming, while a granular filling according to Examples 2-6 is inserted according to known techniques (EP0320580), in order to manufacture gum cores filled with powder filling. The table with examples 7-11 reports the percentages of gum region and filling region, forming the centres (percentages of the centre).

| | % | | | | |
|---|---|---|---|---|---|
| | 7 | 8 | 9 | 10 | 11 |
| | inven- | inven- | inven- | (WO2011- | (refer- |
| Region | tive | tive | tive | 158123) | ence) |
| Gum Region Ex- | 88 | 88 | 88 | 87 | 88 |
| ample 1 | | | | | |
| Granular filling | 12 | | | | |
| Example 2 | | | | | |
| Granular filling | | 12 | | | |
| Example 3 | | | | | |
| Granular filling | | | 12 | | |
| Example 4 | | | | | |
| Granular filling | | | | 13 | |
| Example 5 | | | | | |
| Granular filling | | | | | 12 |
| Example 6 | | | | | |
| Physical form | chewing gum center with granular filling | | | | |
| Comments | No | No | No | Some | Some |
| | leaking | leaking | leaking | leaking | leaking |
| | of | of | of | of | of |
| | filling | filling | filling | filling | filling |

### EXAMPLEs 12-14

### Coating Syrups

Prior Art Syrups for xylitol Coating

| | | | Example 14 - |
|---|---|---|---|
| | Example 12 - | Example 13 - | coating syrup |
| | coating syrup | coating syrup | (WO 2011/158123) |
| Ingredient | % | % | % |
| Xylitol | 60 | 65 | 59.5 |
| Mannitol | 15 | 10 | 0 |
| Water | 15 | 20 | 29.995 |
| Gum Arabic | 7 | 3 | 10.5 |
| E171e | 3 | 2 | |
| E133 | | | 0.005 |
| Total | 100 | 100 | 100 |

The following examples of coating the % of syrups refer to the dry syrups.

### REFERENCE EXAMPLE 15

Centres of example 11 are placed in a pan and coated with known hard coating methods with repeated applications of the coating (engrossing) syrup of example 12.

These first steps of syrup application, in hard coating, are usually called engrossing. In this phase more concentrated syrups are used, usually with a higher content of binders, than in the following steps. Coating powders are also used, but their effect is null on the outermost surface of the dragée, because they are covered during the following application of syrups.

Forced air and distribution times are applied according to known techniques and powders are applied in-between some of the successive applications of syrup of example 12. Powders are applied in a relatively small percentage in the first part of the coating and in-between many successive applications of syrup, their effect is null on the roughness of the final coating. Flavours and sweeteners are also applied, mixed with the syrup.

Immediately after the centres have been engrossed to a pre-determined percentage of the final weight, the smoothing syrup 13 is applied in a number of repeated applications, followed by forced air and distribution times. Finally, carnauba wax is employed as polishing In the described procedure syrup quantity per application, times, temperatures, relative humidity of the air, revolving speed are set in order to obtain a smooth finish in a commercially acceptable time. Relative quantities are reported in the following table in % of the finished dragée (syrups % are reported as dry weight).

| | Example 15 - (not inventive) | | |
|---|---|---|---|
| Ingredient | % | g per piece | Notes |
| Gum centre Example 11 | 80.0000 | 1.6000 | |
| Syrup Example 12 | 10.5450 | 0.2109 | Engrossing |
| Powder | 1.2000 | 0.0240 | phase |
| Flavors and sweeteners | 0.7500 | 0.0150 | (~12.5%) |
| Syrup Example 13 | 7.5000 | 0.1500 | Smoothing and |
| Carnauba Wax | 0.0050 | 0.0001 | Polishing |
| | | | phase (~7.5%) |
| Total | 100.0000 | 2.0000 | |

The outcome is a smooth, white and polished chewing gum dragée. The coating texture is crunchy. after 1-2 days at R.T.

### Reference Example 16

### WO 2011/158123

Centres of example 11 are placed in a pan. The coating syrup of example 14 is added continuously to the chewing gum centres in the rotating pan, till correct and consistent distribution of the syrup is achieved. The powder material, which accounts for most of the coating—xylitol in this example—is than added to centres covered with the syrup over a period of time to allow the powder to adhere to and be incorporated into the coating syrup. The coating is then dried with air, evaporating any water from the syrup, giving a solid but soft coating on the chewing gum pieces.

| | Example 16 (non inventive - | | |
|---|---|---|---|
| | according to WO 2011/158123) | | |
| Ingredient | % | g per piece | Notes |
| Gum centre Example 11 | 70.0000 | 1.4000 | |
| Syrup Example 14 | 8.9400 | 0.1788 | Single |
| Flavour | 0.0600 | 0.0012 | coating |
| Powder 1: Xylitol CM90, Danisco | 20.6400 | 0.4128 | phase |
| Powder 2: gum arabic | 0.3600 | 0.0072 | (~30%) |
| Total | 100.0000 | 2.0000 | |

The outcome is, white-blue chewing gum dragée with an irregular outer coating. The coating texture is soft and lightly crunchy.

### EXAMPLE 17

Centres of example 11 are placed in a pan and coated with known hard coating methods with repeated applications of the engrossing syrup of example 12.

Forced air and distribution times are applied according to known techniques and powders are applied in-between some of the successive applications of syrup of example 12. Powders are applied in a relatively small percentage in the first part of the coating and in-between many successive application of syrup, their effect is null on the roughness of the final coating. Flavours and sweeteners are also applied, mixed with the syrup.

Once the centres have been coated to predetermined weight, quite close to the final weight, accounting for 88% of the total coating (% of the coating), a final coating is performed, which provides a satin finish and consists of the following steps:

i) coating with syrup;

ii) letting a distribution time to elapse;

iii) dusting with powder;

iiii) letting a distribution time to elapse;

iiiii) drying with air;

This final coating is not followed by any other coating step and is repeated 2 times

| | Example 17 (invention) | | |
|---|---|---|---|
| Ingredient | % | g per piece | Notes |
| Gum centre Example 11 | 70 | 1.4 | |
| Syrup Example 12 | 23.5 | 0.47 | Engrossing |
| Coating Powder | 3.5 | 0.07 | coating |
| Flavors and sweeteners | 1 | 0.02 | phase |
| | | | (~28%) |
| Syrup Example 12 | 1.6 | 0.032 | Final satin |
| Powder: 80% mannitol, | 0.4 | 0.008 | coating |
| 20% gum arabic | | | phase |
| | | | (~2%) |
| Total | 100.0000 | 2.0000 | |

The outcome is a white and slightly rough dragée, with a satin apparel. The coating texture is crunchy.

### EXAMPLE 18

### Measurements

Ten chewing gum dragée from each of the examples 15, 16 and 17 are subjected to the measurement of superficial roughness with a profilometer Form Talysurf Intra (Taylor Hobson). The Ra and Rz are calculated by the instrument software. Average values over 10 different dragée per example are reported

| | | Example 15 | | Example 16 |
|---|---|---|---|---|
| | | (reference) | Example 17 | (reference) |
| Ra | average | 0.47 | 3.34 | 7.12 |
| | standard | 0.10 | 0.86 | 0.97 |
| | deviation | | | |
| Rz | average | 3.1 | 18.37 | 36.5 |
| | standard | 1.27 | 3.64 | 3.42 |
| | deviation | | | |

The roughness parameters Ra and Rz of the example 17 are intermediate when confronted to those of example 15 (prior art polished dragée) or example 16 (prior art rough coating). Average values±standard deviation are not overlapping, thus indicating that roughness of example 17 is clearly distinct from that of example 15 and 16.

1. A chewing gum comprising two regions:
a) a gum region characterised by the presence of at least one gum base and at least one sweetener;
b) a coating region comprising more than 50% of sugar or polyols and combination thereof, wherein the outermost part has a satin effect and is characterised by an average roughness Ra ranging between 1 and 6 μm.

2. A chewing gum according to claims 1 wherein the roughness is further characterised by an average roughness Rz ranging between 5 and 30 μm.

3. A chewing gum according to claim 2 wherein the average roughness Ra ranges between 2 and 5 μm and the average roughness Rz ranges between 10 and 25 μm.

4. A chewing gum according to claim 1, comprising a granular filling region, contained inside the gum region a), wherein said granular filling is characterized by a particulate material in a quantity higher than 98% and a liquid in quantity comprised between 0.1% and 2% by weight of the filling.

5. A chewing gum according to claim 4 wherein said particulate comprises dextrose monohydrate, sorbitol, erythritol, xylitol and mixtures thereof, in crystals with an average particle size ranging between 40 μm and 1000 μm.

6. A chewing gum according to claim 4, wherein said liquid component is contained in a percentage between 0.1 and 1% by weight of the filling.

7. A chewing gum according to claim 4, wherein said liquid component is constituted by C₆-C₁₂ chain triglycerides.

8. A process for manufacturing the chewing gums of claim 1 wherein dry semi-finished dragées, coated from 50% to 99% of the coating weight, are subjected to a final coating step comprising
i) coating with syrup;
ii) dusting with a coating material in powder comprising polyols;
iii) drying with air;
until 100% of the coating weight is obtained without any polishing step and with an outermost satin coating.

9. A process according to claim 8 wherein the powder of steps e) and g) is characterised by a particle size between 30 μm and 400 ρm μm.

10. A process according to claim 9 wherein said powder comprises sorbitol, isomalt, maltitol, xylitol, mannitol, erythritol, gum arabic and combinations thereof.

11. A process according to claim 8 wherein the ratio between the coating syrup and the material in powder form employed in the satin coating is between 2:1 and 4:1.
